(19) United States
(12) Patent Application Publication
(10) Pub. No.: US 2011/0163182 A1
(43) Pub. Date: Jul. 7, 2011

(54) OVERHEAD OR LATERAL SHOWER HEAD

(76) Inventors: Bernd Bischoff, Hemer (DE); Claudia Schroeder, Iserlohn (DE)

(21) Appl. No.: 12/986,907

(22) Filed: Jan. 7, 2011

Related U.S. Application Data
(63) Continuation of application No. PCT/EP2009/004841, filed on Jul. 4, 2009.

(30) Foreign Application Priority Data
Jul. 7, 2008 (DE) 10 2008 031 558.3

(51) Int. Cl. B05B 15/06

(52) U.S. Cl. 239/209

(57) ABSTRACT

A shower head or lateral shower head is provided for installation in a ceiling or wall, having a pivotable jet-producing device which is mounted in a ball housing by a ball-and-socket joint through which water flows, the housing surrounding the jet-producing device and being arranged in a manner both tiltable and displaceable in a direction perpendicular to the ceiling or wall, and the housing having an outer flange which extends to the surface of the ceiling or wall. A connection element is provided between a water connection and the ball housing.

This nonprovisional application is a continuation of International Application No. PCT/EP2009/004841, which was filed on Jul. 4, 2009, and which claims priority to German Patent Application No. DE 10 2008 031 558.3, which was filed in Germany on Jul. 7, 2008, and which are both herein incorporated by reference.

### BACKGROUND OF THE INVENTION

1. Field of the Invention

The present invention relates to an overhead or lateral showerhead for installation in a ceiling or wall with a pivotable jet producing unit.

2. Description of the Background Art

In fixedly installed overhead or lateral showerheads, it is advantageous for the tilt and direction of the spray jet to be varied. In modern overhead and lateral showerheads, it is desirable in addition that these be made as flat as possible or even almost flush with the ceiling or wall surface. For example, DE 100 11 504 A1 discloses a showerhead with a spherical section and a spherical shell, which in turn has guides arranged perpendicular to one another, so that the showerhead can be moved in a vertical and a horizontal axis. Furthermore, WO 2006/093954 A1, which corresponds to U.S. Pat. Nos. 7,628,341 and 7,770,825, discloses a lateral showerhead for installation in a wall, whose jet producing element is pivotable all around by means of a coupling assembly rotatable around two axes arranged perpendicular to one another.

If the showerhead is to be flush with the ceiling or wall surface, apart from the flattest construction and design possible, it is necessary for the showerhead to be adaptable to different wall thicknesses or to different wall constructions or coverings.

### SUMMARY OF THE INVENTION

It is therefore an object of the present invention to provide a design for overhead and lateral showerheads that meet the aforementioned requirements.

The invention provides an overhead or lateral showerhead for installation in a wall or ceiling which has a pivotable jet producing unit. The jet producing unit is mounted by means of a ball joint, through which water flows, and whose associated ball housing surrounds the jet producing unit and is arranged tiltable. Further, the ball housing has an outer flange, which extends to the ceiling or wall surface. An overhead or lateral showerhead with very small depth is achieved by the compact design of the ball joint subassembly, which comprises the ball housing and the ball joint, and the jet producing unit. To adapt to different ceiling or wall thicknesses, a connection element is provided between a water connection and the ball housing. This makes possible the displaceable arrangement of the ball housing substantially perpendicular to the ceiling or wall surface. Overall, apart from the depth compensation, a fine adjustment of the showerhead and optionally an angle adjustment to adapt to possible slanting of the ceiling or wall are possible.

According to an embodiment of the invention, fasteners are provided with which the ball housing is fixed to the connection element and simultaneously the outer flange of the ball housing is secured against the ceiling or wall surface.

Particularly in the case of overhead or lateral showerheads with an angular outer contour, it is advantageous when the ball housing can be fastened to a disk or annular disk, mounted rotatably on the connection element, by means of screws, because the orientation of the showerhead can then occur independent of the position of the fastener. Because of the rotatable arrangement of the annular disk, the position of the screw holes can be matched to the position of the ball housing. The orientation of the ball housing does not need to be changed further during the fixation thereof.

The annular disk contains a plurality of tapped holes for receiving the screws and is mounted securely in a groove on the connection element in the axial direction. The ball housing can be oriented initially according to the wall covering, so that in the case of rectangular showerheads the housings are oriented precisely horizontally and vertically. Then, the ball housing is fastened to the connection element, used for depth adjustment, by means of screws. To this end, the connection element can be shortened and/or be made of multiple parts.

The connection element comprises a connection thread on the one side, which corresponds to the thread of the water connection. On the side facing the jet producing unit, the cross section of the connection element increases abruptly, so that a seat for a connection fitting of the ball housing is formed. Advantageously, the connection element and/or seat for the connection fitting of the ball housing are formed rotationally symmetric, so that the position of the connection element is immaterial for the orientation of the ball housing. The connection fitting of the ball housing is guided in turn displaceably and tiltably in the seat of the connection element. Its final position and thereby the position of the ball housing are also determined by the screws described above. As a result, an especially fine orientation and adjustment of the ball housing is possible.

Furthermore, the ball housing is formed so that in the connection fitting of the ball housing a seat for a screen and/or a backflow preventer is provided, which results in a space-saving arrangement for these structural parts.

To seal the overhead or lateral showerhead relative to the ceiling or wall, the connection element, the ball housing with the ball joint, and the jet producing unit are arranged in an installation housing. Said installation housing can also be shortened and/or be made of many parts.

Typically, in all fixtures which are installed in the ceiling or wall, for decorative reasons trims or frames are provided on the anterior side, which surround the fixture, in this case the side or ceiling showerhead, and form a seal relative to the wall. Typically, they also have sealing elements, which seal either between the fixture and the wall or between the trim and the interior of the fixture. In rectangular or square overhead or lateral showerheads, care must be taken that the trim, which covers the ball housing, is made so that during pivoting of the jet producing unit it does not afford a view of the interior or the construction of the showerhead.

In an embodiment, he trim can be made so that it covers the outwardly directed side of the ball housing and provides a view only of the area of the joint socket in which the ball of the joint and the adjacent jet producing unit are fastened.

For fastening the trim, which completely covers the outer flange of the ball housing, the ball housing is placed against the wall or ceiling surface and therefore secured simultaneously with the trim.

In addition, the overhead or lateral showerhead may have water draining devices at the outwardly and/or inwardly directed side of the ball housing, so that both the water that penetrates into the connection area behind the ball housing and the water that enters the space between the ball housing and jet producing unit can be brought out again from the lateral showerhead.

An embodiment of the invention provides that a regulating device is provided to control the flow volume at the overhead or lateral showerhead. To this end, an adjusting nut with variable opening cross sections is provided in the connection area of the ball joint, through which water flows, and the jet producing unit. When a plurality of overhead or lateral showerheads are connected to a common water connection, therefore a uniform spray pattern can be achieved by means of the regulation of the flow-through openings despite different water pressures at the individual overhead or lateral showerheads.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a section through an overhead or lateral showerhead in the installed state with a minimal installation depth;

FIG. 2 shows a section through the overhead or lateral showerhead of FIG. 1 in the pivoted state;

FIG. 3 shows a section through an overhead or lateral showerhead in the installed state with a maximum installation depth; and

FIG. 4 shows a section through a variant of an overhead and lateral showerhead in the installed state.

### DETAILED DESCRIPTION

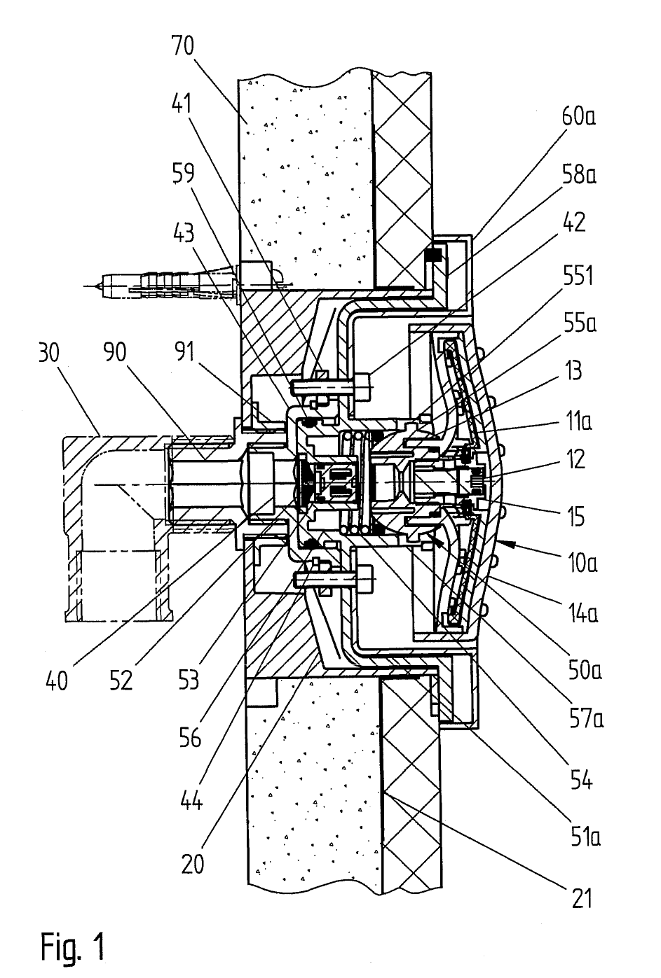

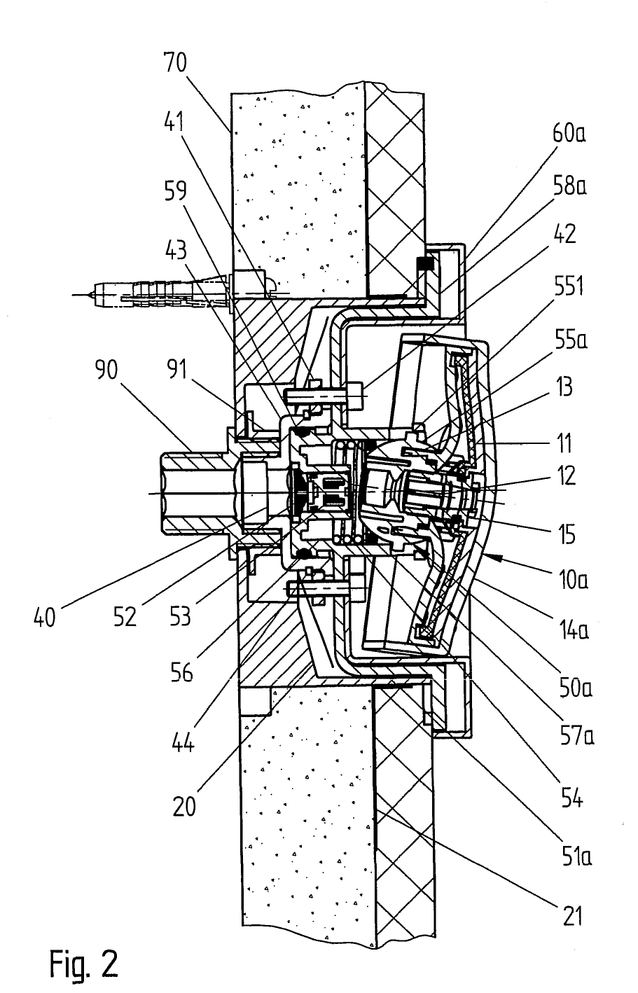

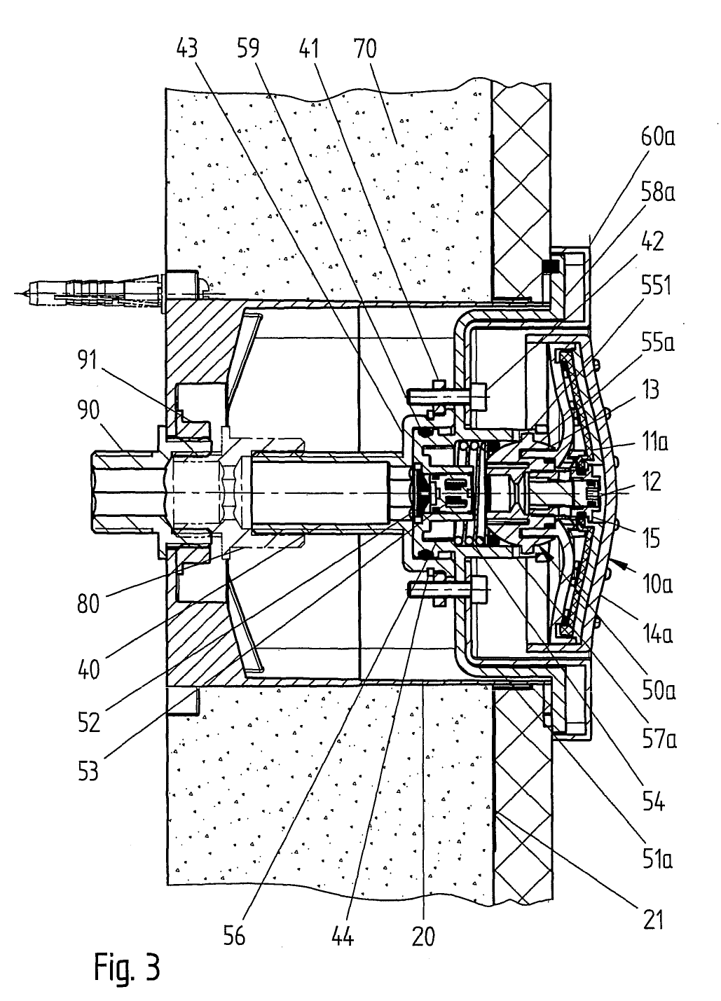

FIGS. 1 through 4 show a lateral showerhead with a pivotable jet producing unit 10a, 10b in the installed state. The lateral showerhead comprises a jet producing unit 10a, 10b, which is mounted pivotable in all directions in a ball housing 51a, 51b. Ball housing 51a, 51b is formed so that, on the one hand, it forms a joint socket 57a, 57b for a ball joint 55a, 55b, through which water flows, but simultaneously surrounds the entire jet producing unit 10a, 10b and by means of an outer flange 58a, 58b forms a stop for the lateral showerhead at the wall surface.

A water connection 30, provided during the framing, is located in wall 70. First, a connection fitting 90 is mounted on water connection 30. Said connection fitting 90 has a flange against which a mounting box 20 lies, which is pushed onto connection fitting 90. Mounting box 20 is fastened from its inside with a threaded nut 91 to connection fitting 90. Further, after alignment mounting box 20 can be affixed to wall 70 by means of anchor bolts and screws. After plastering, mounting box 20 is sealed in the outer area relative to the wall with a sealing collar 21, onto which the decorative wall covering can be applied. Thereafter, mounting box 20 is shortened according to its installation depth, so that it ends flush with the wall covering, for example, the tile level.

During mounting of the lateral showerhead, first the required installation depth between the wall surface or outer edge of the installed mounting box 20 and the connection fitting 90 is to be measured. In addition to connection element 40, an extension piece 80 may be necessary, which must correspond to the connecting geometries of connection fitting 90 and connection element 40, to assure a tight connection.

Then, connection element 40 is fastened either directly to connection fitting 90 or extension piece 80. Connection element 40 with suitable tolerances has been adjusted beforehand to the measured installation depth.

On the side, facing the wall surface, of connection element 40, the cross section of connection element 40 increases abruptly, so that a seat 43 for a connection fitting 56 of ball housing 51a, 51b arises. In the delivered state, ball housing 51a, 51b is already equipped with a backflow preventer 53 and a screen 52, which is arranged in connection fitting 56. Ball housing 51a, 51b is already preassembled with a spring 54, a disk, and a seal, which are arranged below ball joint 55a, and ball joint 55a, 55b itself to form a subassembly.

For attachment of ball housing 51a, 51b to connection element 40, a rotatable annular disk 41, which is secured in the axial direction, is arranged at connection element 40. In the present case, annular disk 41 lies against a flange of connection element 40 and is fixed by means of a retaining ring 44. When the position of ball housing 51a, 51b is determined relative to the wall surface, ball housing 51a, 51b or according to the embodiment a subassembly comprising a trim 60a and ball housing 51a is screwed onto annular disk 41 with screws 42.

Because connection fitting 56 of ball housing 51a, 51b is mounted axially displaceable and tiltable in the seat of connection element 40, ball housing 51a, 51b can be adjusted very precisely to the wall surface. Even after the adjustment of the length of connection element 40, a fine adjustment in the axial direction, therefore substantially perpendicular to the wall surface, and an angle adjustment to a possible slanting of the wall surface can still occur. The end position of ball housing 51a, 51b and therefore the lateral showerhead is fixed according to the orientation of ball housing 51a, 51b by screws 42. Alternatively, annular disk 41 may also be provided with fixed threaded bolts and ball housing 51a, 51b or the entire subassembly 51a, 60a be fastened with threaded nuts to the threaded bolts.

After ball housing 51a, 51b, in which ball joint 55a, 55b has already been premounted, is screwed together, jet producing unit 10a, 10b, which comprises a welding subassembly 11a, 11b, is fastened to ball joint 55a, 55b. Whereas a ring-shaped groove is provided on ball joint 55a, 55b, welding subassembly 11a, 11b has a mounting cylinder 13, which is pushed into the groove. The final fastening of welding subassembly 11a, 11b, which comprises a water distribution chamber and a spray producer with water outlet openings, to ball joint 55a, 55b occurs via a central screw 15, in which a regulating screw 12 is integrated. The flow volume per lateral showerhead is set by means of regulating screw 12. In an arrangement of a plurality of lateral showerheads in a row to a water connection, therefore the flow volume can be adjusted to the different pressure conditions, so that uniform spray patterns can be generated. Finally, a cover 14a, 14b, which covers welding subassembly 11a, 11b all around, can be pushed onto welding subassembly 11a, 11b.

Very small installation depths of less than 5 cm can be realized by the compact design in the lateral showerhead of the invention. With a similar lateral showerhead design, it is also possible, however, to achieve installation depths of 9 to 10 cm by means of the variable connection element 40.

FIGS. 1 through 3 show lateral showerheads with a pivotable angular jet producing unit 10a. In the mounting of the lateral showerhead, the precise orientation of the angular jet producing unit 10a relative to ball housing 51a is the main focus. For this reason, ball joint 55a has a component for rotational fixation 551 of jet producing unit 10a. For this purpose, fittings or pins can be provided on ball joint 55a, which correspond to the recesses provided for them in joint socket 57a, so that jet producing unit 10a can be installed only in certain predefined positions.

In the shown lateral showerheads, a trim 60a is provided, which surrounds the outwardly directed side of ball housing 51a with the exception of joint socket 57. This is screwed together with ball housing 51a and secured. The mounting of jet producing unit 10a occurs thereafter.

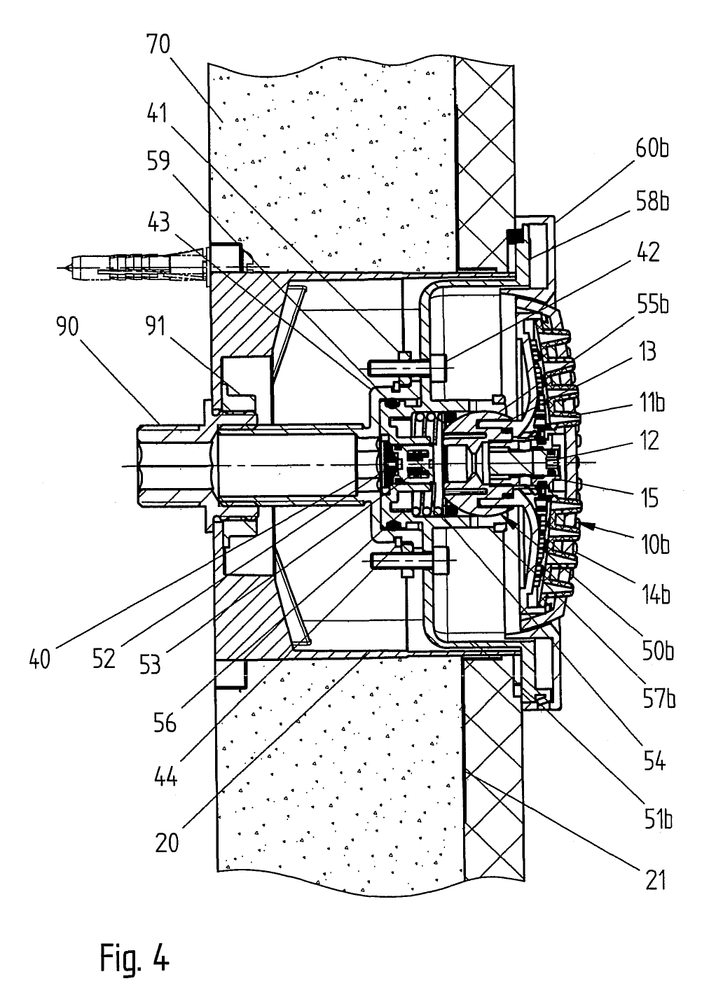

In contrast to this, FIG. 4 shows a lateral showerhead with a pivotable round jet producing unit 10b in the installed state. In contrast to the angular design, in the round variant no rotational fixation is needed during the fastening of jet producing unit 10b. During the mounting process, the fastening of jet producing unit 10b occurs before the fastening of trim 60b. Instead of a screw connection, ball housing 51b is provided with latching hooks and trim 60b is provided with corresponding recesses or grooves, so that trim 60b can be attached form-fittingly to ball housing 51b.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An overhead or lateral showerhead for installation in a ceiling or wall surface, the showerhead comprising:
a pivotable jet producing unit, which is mounted in a ball housing via a ball joint, through which water flows, the ball housing being arranged tiltable and displaceable substantially perpendicular to the ceiling or wall, the ball housing adapted to have water flow therethrough, the ball housing substantially surrounding the jet producing unit, the ball housing having an outer flange that extends towards the ceiling or the wall surface; and
a connection element arranged between a water connection and the ball housing.

2. The overhead or lateral showerhead according to claim 1, wherein a fastener is provided with which the ball housing is fixable to the connection element and wherein the outer flange of the ball housing is secured against the ceiling or wall surface via the fastener.

3. The overhead or lateral showerhead according to claim 2, wherein the ball housing is fastened by screws to an annular disk mounted rotatably on the connection element.

4. The overhead or lateral showerhead according to claim 1, wherein the connection element is adapted to be shortened and/or be made of many parts.

5. The overhead or lateral showerhead according to claim 1, wherein the ball housing comprises a connection fitting, which is guided tiltably and displaceably in a seat of the connection element.

6. The overhead or lateral showerhead according to claim 5, wherein in the connection fitting of the ball housing, a seat for a screen and/or a backflow preventer is arranged.

7. The overhead or lateral showerhead according to claim 1, wherein the connection element, the ball housing with the ball joint, and the jet producing unit are arranged in an installation housing.

8. The overhead or lateral showerhead according to claim 7, wherein the installation housing is adapted to be shortened.

9. The overhead or lateral showerhead according to claim 1, wherein a trim is provided, which covers the outwardly directed side of the ball housing and thereby the ball housing is placed against the ceiling or wall surface.

10. The overhead or lateral showerhead according to claim 1, wherein a regulating device is provided to control the flow volume.

11. The overhead or lateral showerhead according to claim 10, wherein in the connecting area of the ball joint, through which water flows, and the jet producing unit an adjusting nut with variable opening cross sections is arranged.

12. The overhead or lateral showerhead according to claim 1, wherein water draining devices are provided at an outwardly and/or inwardly directed side of the ball housing.

13. An arrangement of overhead or lateral showerheads according to claim 1, wherein at least one additional overhead or lateral showerhead is provided, which is connected to a water connection.
